(19) United States
(12) Patent Application Publication
(10) Pub. No.: US 2010/0328214 A1
(43) Pub. Date: Dec. 30, 2010

(54) Cursor Control System and Method

(76) Inventor: Hui-Hu LIANG, Siu Shui Hsiang (TW)

Correspondence Address: Jackson Intellectual Property Group PLLC, 106 Starvale Lane, Shipman, VA, 22971, US

(21) Appl. No.: 12/493,178

(22) Filed: Jun. 27, 2009

(51) Int. Cl. G06F 3/033

(52) U.S. Cl. 345/163

(57) ABSTRACT

A cursor control system and method includes a signal transmitter and a signal receiver in conjunction with a display control machine, a projector and a monitor. The display control machine outputs an image to be transmitted to the monitor via a signal transmission or magnified and projected to a screen via the projector. With the relative position between the signal transmitter and the signal receiver, a cursor displayed on the image is remote-controlled by operating the signal receiver. The signal receiver gets the relative position of the cursor displayed on the image via the electric wave emitted from the signal transmitter. The signal receiver is operated to command the cursor displayed on the image direct for selection, execution, print, scrolling the window, hot key and so on, providing convenient use, quick and easy operation, and long rage control.

### BACKGROUND OF THE INVENTION

1. Field of the Invention

The present invention relates to a cursor control system and method, using a signal transmitter and a signal receiver in conjunction with a display control machine, a projector and a monitor. The display control machine outputs an image to be transmitted via a signal transmission. The signal receiver gets a relative position of a cursor displayed on the image via the electric wave emitted from the signal transmitter. The signal receiver is operated to command the cursor displayed on the image direct. Alternatively, the image of the display control machine is magnified and projected to a screen via the projector. With the relative position between the signal transmitter and the signal receiver, the cursor displayed on the image is remote-controlled by operating the signal receiver. The signal receiver is operated to command the cursor displayed on the image direct for selection, execution, print, scrolling the window, hot key and so on, providing convenient use, quick and easy operation, and long rage control.

2. Description of the Prior Art

A mouse is connected to a personal computer or a notebook with a USB line or Bluetooth as a signal transmission media. The mouse is placed on a flat surface to be moved for controlling a cursor by operating functional keys thereon, such as selection, execution, print, scrolling the window, hot key, which is convenient in use.

When having a report, briefing, discussion, or teaching, the personal computer or notebook is operated for outputting an image to be transmitted a screen via a projector. The user may point out an import sentence or subject with a laser pointer. Furthermore, the user may use Bluetooth as a transmission signal for controlling a simple command, such as page up or page down, which is convenient for the speaker to control the window.

The prior art has several shortcomings as follows:

1. The wired mouse or wireless mouse must be placed on a flat surface to be moved for controlling movement of the cursor along with the traveling direction of the mouse. The mouse is unable to be operated at any desired position, except the flat surface like a table. This is very inconvenient.

2. The image signal is transmitted to the projector via the personal computer or notebook, and the projector projects the image on a screen. However, controlling the mouse still depends on the personal computer or notebook. Therefore, the user is unable to be far away from the computer and must face the control image for operating the mouse.

3. If the lightness of the laser pointer is not enough when having a report, briefing, discussion or teaching, the screen is unable to show the lightness of the laser pointer. In addition, the laser pointer doesn't have the function to amend or draw. It is necessary to use the mouse for explaining clearly.

### SUMMARY OF THE INVENTION

According to a first aspect of the present invention, there is provided a cursor control system, comprising a signal transmitter and a signal receiver in conjunction with a display control machine, a projector and a monitor, the display control machine outputting an image to be transmitted the monitor via a signal transmission or magnified and projected to a screen via the projector, the signal receiver getting a relative position of a cursor displayed on the image via the electric wave emitted from the signal transmitter, the signal receiver being operated to command the cursor displayed on the image direct for selection, execution, print, scrolling the window, hot key and so on, providing convenient use, quick and easy operation, and long rage control.

Preferably, the signal transmitter and the signal receiver are connected to the display control machine, the projector and the monitor with signal transmission lines for constituting a signal transmission mode.

Preferably, a software driven program is executed in a central processing unit (CPU) of the display control machine. The display control machine outputs the image to be transmitted to the monitor via a signal transmission line. The signal transmitter and the signal receiver are connected with the display control machine via signal transmission lines or a radio transmission device. The signal receiver is operated to command the cursor displayed on the image direct, providing a convenient operation and not being limited by the circumstance.

Preferably, the signal transmitter and the signal receiver use a Bluetooth wireless transmission device or a radio transmission device to connect with the display control machine for providing a convenient operation.

Preferably, the projector uses a signal transmission line to connect with the display control machine and a screen instead of the monitor so that the image of the display control machine is magnified and projected on the screen. The signal transmitter and the signal receiver are connected with the display control machine via signal transmission lines or a radio transmission device. The signal receiver is operated to control movement of the cursor displayed on the image direct, providing an exact, convenient, and quick use.

According to a second aspect of the present invention, there is provided a cursor control method, comprising the steps of:

(a) executing a software driven program in a CPU of a display control machine;

(b) using an internal signal transmission line or an external signal transmission line to connect the display control machine with a monitor or a projector;

(c) using a signal transmission line or a radio transmission device to connect the display control machine with a signal transmitter and a signal receiver, respectively;

(d) the signal receiver getting a relative position of a cursor displayed on an image via an electric wave emitted from the signal transmitter, operating the signal receiver to control movement of the cursor displayed on the image; and

(e) controlling the cursor displayed at the relative position of the image to command the image direct for selection, execution, print, scrolling the window, hot key.

thereby, the image of the display control machine being outputted to the monitor via the external signal transmission line or the internal signal transmission line or to the screen via the projector, with the relative position between the signal transmitter and the signal receiver, the cursor displayed on the image being remote-controlled by operating the signal receiver, providing convenient use, quick and easy operation, and long rage control.

### BRIEF DESCRIPTION OF THE DRAWINGS

FIG. 1 is a block diagram of a cursor control system of the present invention;

FIGS. 1-A and 1-B are schematic views of the present invention showing the connection of a signal transmitter and a signal receiver in conjunction with a display control machine and a monitor;

FIG. 1-C is a schematic view of the present invention showing the connection of the signal transmitter and the signal receiver in conjunction with the display control machine and a projector;

FIGS. 2-A and 2-B are schematic views of the present invention showing the connection of the signal transmitter and the signal receiver in conjunction with the display control machine and the monitor via a radio device; and

FIG. 2-C is a schematic view of the present invention showing the connection of the signal transmitter and the signal receiver in conjunction with the display control machine and the projector via the radio device.

### DETAILED DESCRIPTION OF THE PREFERRED EMBODIMENTS

Embodiments of the present invention will now be described, by way of example only, with reference to the accompanying drawings.

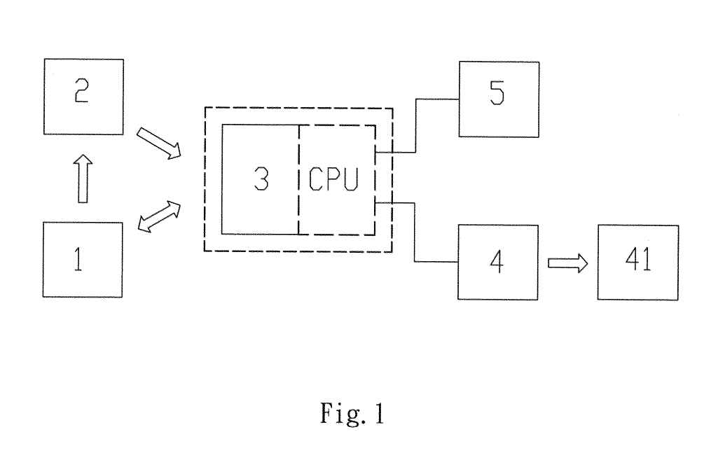

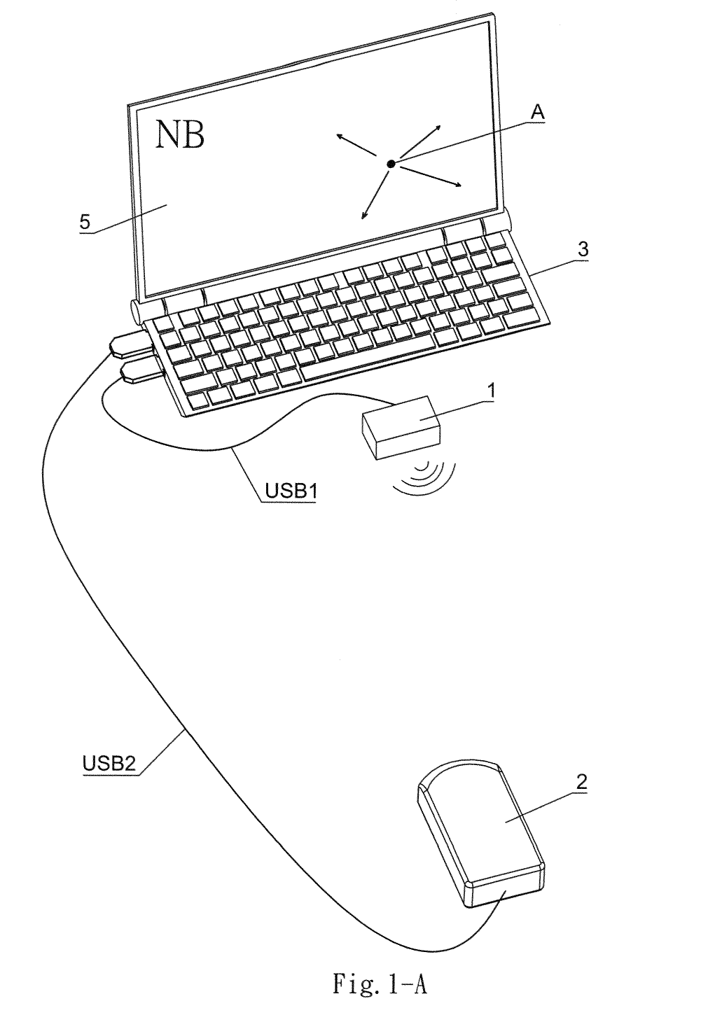

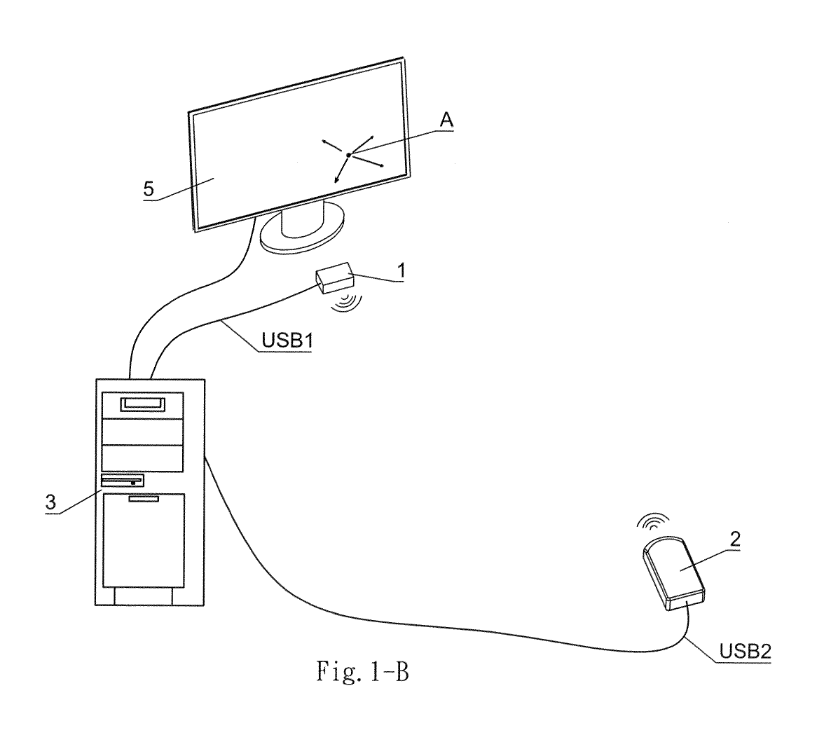

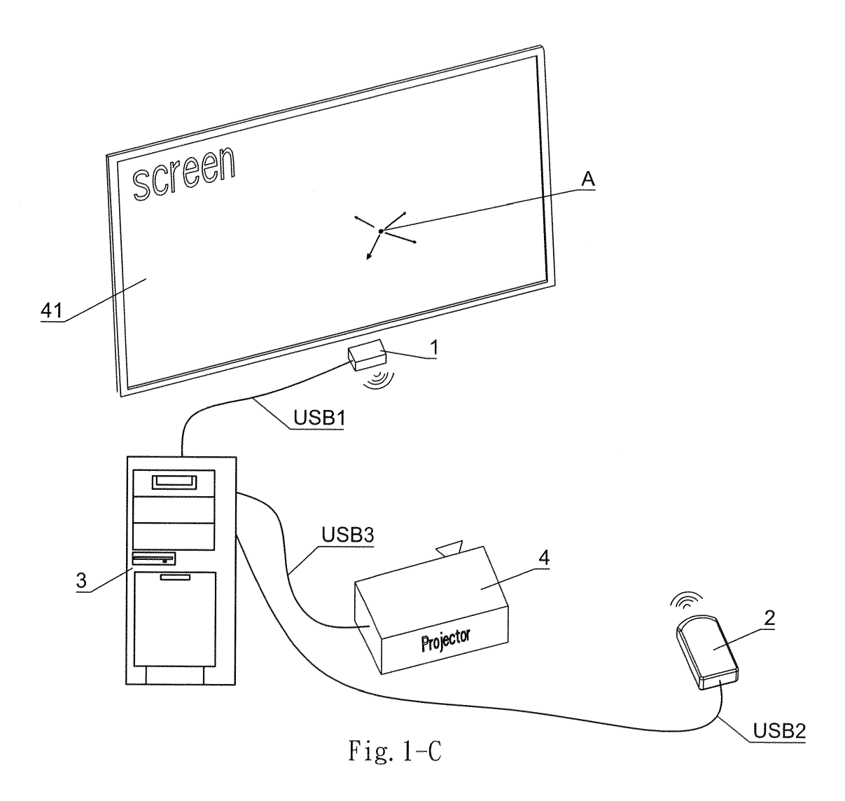

Referring to FIGS. 1, 1-A, 1-B, 2-A, 2-B, a cursor control system of the present invention comprises a signal transmitter 1 and a signal receiver 2 in conjunction with a display control machine 3, a projector 4, and a monitor 5. The display control machine 3 outputs an image to a monitor 5 via an internal signal transmission line or an external signal transmission line, as shown in FIGS. 1-A, 1-B, 2-A, 2-B; or the display control machine 3 is connected to a projector 4 via a signal transmission line USB 3, as shown in FIGS. 1-C, 2-C. The image is projected to a screen 41. With the relative position between the signal transmitter 1 and the signal receiver 2, the signal receiver 2 is operated to control movement of the cursor displayed on the image, such as selection, execution, print, scrolling the window, hot key, having the same functions as a mouse. The present invention is convenient in use, quick and easy for operation, and convenient for portability.

As shown in FIGS. 1-A to 1-C, signal transmission lines USB1 to 3 are used to connect the signal transmitter 1 and the signal receiver 2 with the display control machine 3, the projector 4 or the monitor 5 for constituting a signal transmission mode.

Referring to FIGS. 1, 1-A to 1-C, a software driven program is executed in a central processing unit (CPU) of the display control machine 3. The display control machine 3 may be a personal computer or a notebook to output the image to the monitor 5 via an external signal transmission line or an internal signal transmission line. Alternatively, the image is transmitted to the screen 41 instead of the monitor 5 via the projector 4. The signal transmitter 1 and the signal receiver 2 are connected with the display control machine 3 via the signal transmission lines USB1 and USB2. The signal receiver 2 gets the relative position of the cursor A displayed on the image via the electric wave emitted from the signal transmitter 1. The signal transmitter 1 and the signal receiver 2 are connected with the CPU of the display control machine 3 via the signal transmission lines USB1 and USB2. The signal receiver 2 is operated to control movement of the cursor A displayed on the image, providing a convenient operation and not being limited by the circumstance.

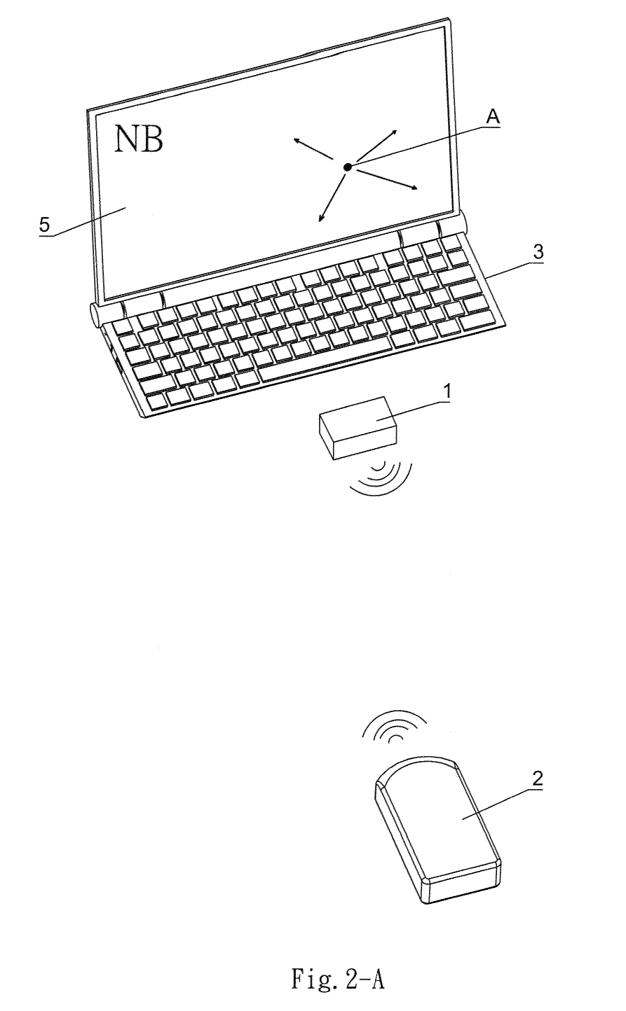

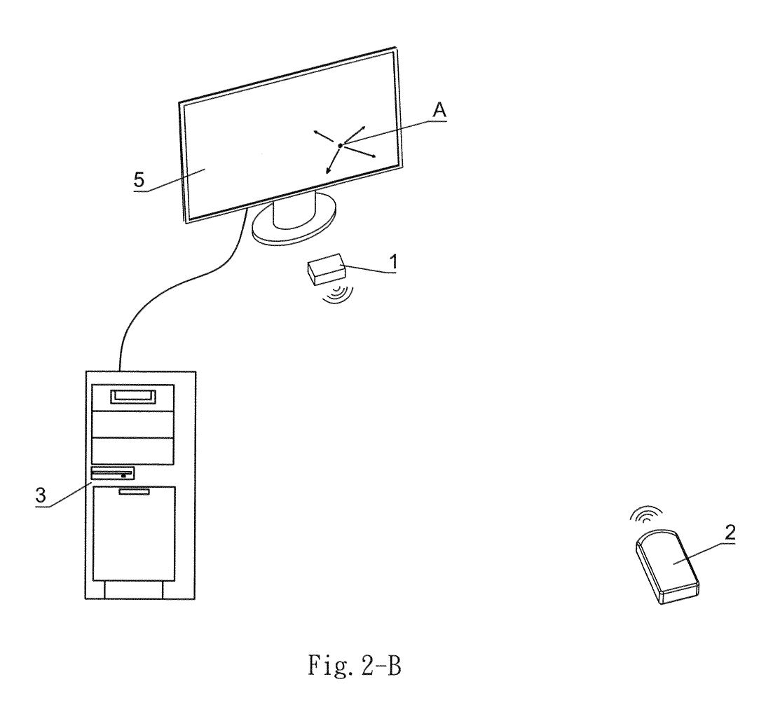

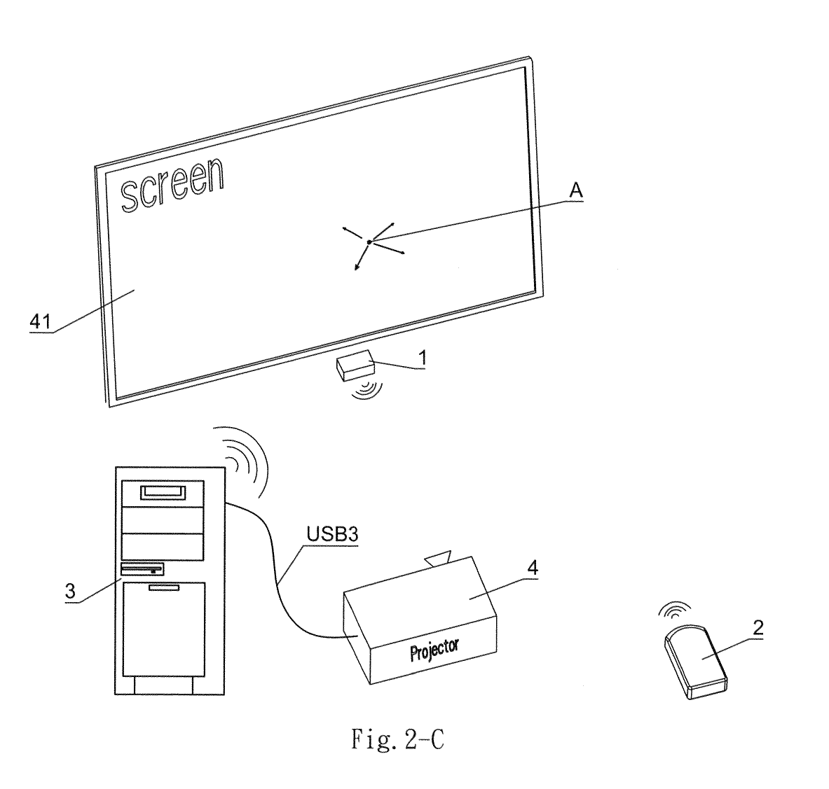

Referring to FIGS. 2-A to 2-C, the signal transmitter 1 and the signal receiver 2 of the present invention may use a Bluetooth wireless transmission device or other radio transmission devices to connect with the display control machine 3 (this is a conventional technique, and doesn't be described hereinafter) for providing a convenient operation.

Referring to FIGS. 1, 2-A to 2-C, a software driven program is executed in a central processing unit (CPU) of the display control machine 3. The display control machine 3 may be a personal computer or a notebook to output the image to the monitor 5 via an external signal transmission line or an internal signal transmission line. Alternatively, the image is transmitted to the screen 41 instead of the monitor 5 via the projector 4, as shown in FIG. 1-C. The signal transmitter 1 and the signal receiver 2 are connected with the display control machine 3 via the Bluetooth wireless transmission device or other radio transmission devices. The signal receiver 2 could get the relative position of the cursor A displayed on the image via the electric wave emitted from the signal transmitter 1. The signal transmitter 1 and the signal receiver 2 are connected with the CPU of the display control machine 3 via the Bluetooth wireless transmission device or other radio transmission devices. The signal receiver 2 is operated to control movement of the cursor A displayed on the image, providing a convenient operation and not being limited by the circumstance.

In this embodiment, the signal transmitter 1 and the signal receiver 2 are constituted with Complementary Metal-Oxide-Semiconductor (CMOS) because the CMOS has the advantages of low price, low power consumption, small size and the like (this is a conventional technique, and doesn't be described hereinafter), which is applied to the demand for design and practical for wireless transmission in use. In addition, the signal receiver 2 may comprises a left key, a right key, a roller, a hot key and so on, having the same functions as a mouse. The signal receiver 2 may further comprise a power switch for a user to operate at an appropriate location, providing a humanistic effect.

Referring to the FIGS. 1, 1-A to 1-C, 2-A to 2-C, a cursor control method of the present invention comprises the steps of:

(a) executing a software driven program in a CPU of a display control machine 3;

(b) using a signal transmission line to connect the display control machine 3 with a monitor 5 or a projector 4;

(c) using signal transmission lines USB 1 and USB2 to connect the display control machine 3 with a signal transmitter 1 and a signal receiver 2, or using a Bluetooth wireless transmission device or other radio transmission devices to connect the display control machine 3 with the signal transmitter 1 and the signal receiver 2;

(d) the signal receiver getting a relative position of a cursor A displayed on an image via an electric wave emitted from the signal transmitter, operating the signal receiver connected with the CPU to control movement of the cursor A displayed on the image; and

(e) controlling the cursor A displayed at the relative position of the image to command the image direct for selection, execution, print, scrolling the window, hot key and so on.

Accordingly, the image of display control machine 3 is transmitted to the monitor 5 for displaying via an external transmission line or an internal transmission line. With the relative position between the signal transmitter 1 and the signal receiver 2, the cursor displayed on the image is remote-controlled by operating the signal receiver 2, providing convenient use, quick and easy operation, and long rage control.

Referring to FIGS. 1, 1C, 2C, the projector 4 uses the signal transmission line USB 3 to connect with the display control machine 3 and uses the screen 41 instead of the monitor 5 so that the image of the display control machine 3 is magnified and projected on the screen 41. The signal transmitter 1 and the signal receiver 2 are connected with the display control machine 3 via the signal transmission lines USB1, USB2, or a radio transmission device. The signal receiver 2 is operated to control movement of the cursor A displayed on the image providing an exact, convenient and quick use.

Referring to FIGS. 1, 1-A to 1-C, 2-A to 2-C, when the signal transmitter 1 and the signal receiver 2 are in use, another user may move a mouse connected with the display control machine 3 to interchange operation. This is very convenient in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cursor control system, comprising a signal transmitter and a signal receiver in conjunction with a display control machine, a projector and a monitor, the display control machine outputting an image to be transmitted to the monitor via a signal transmission or magnified and projected to a screen via the projector, with a relative position between the signal transmitter and the signal receiver, a cursor displayed on the image being remote-controlled by operating the signal receiver;
the signal transmitter, connected with the display control machine and located at the relative position with respect to the signal receiver, outputting an electric wave continuously;
the signal receiver, connected with the display control machine and located within the range of the electric wave emitted from the signal transmitter, getting the relative position of the cursor displayed on the image to command the cursor for selection, execution, print, scrolling, or hot key;
the display control machine, having a built-in central processing unit (CPU) and a soft driven program executed by the CPU, the CPU connecting the signal transmitter with the signal receiver via the signal transmission, the signal receiver being operated to control a relative movement of the cursor displayed on the image;
thereby, the signal receiver getting the relative position of the cursor displayed on the image via the electric wave emitted from the signal transmitter, the signal receiver being operated to control movement the cursor displayed on the image.

2. The cursor control system as claimed in claim 1, wherein the signal transmitter and the signal receiver are connected to the display control machine, the projector and the monitor with USB signal transmission lines for constituting a signal transmission mode.

3. The cursor control system as claimed in claim 1, wherein the signal transmitter and the signal receiver are connected to the display control machine with a Bluetooth wireless transmission device or a radio transmission device for constituting a signal transmission mode.

4. The cursor control system as claimed in claim 1, wherein the signal transmitter and the signal receiver are constituted with Complementary Metal-Oxide-Semiconductor (CMOS).

5. The cursor control system as claimed in claim 1, wherein the signal receiver comprises a left key, a right key, a roller, and a hot key, having mouse functions.

6. The cursor control system as claimed in claim 1, wherein the signal receiver comprises a power switch for a user to operate at an appropriate location.

7. The cursor control system as claimed in claim 1, wherein, a mouse connected with the display control machine is moved for interchanging operation when the signal transmitter and the signal receiver are in use.

8. A cursor control method, comprising the steps of:
(a) executing a software driven program in a CPU of a display control machine;
(b) using a signal transmission line to connect the display control machine with a monitor or a projector;
(c) using a USB (Universal Serial Bus) signal transmission line or a radio transmission device to connect the display control machine with a signal transmitter and a signal receiver, respectively;
(d) the signal receiver getting a relative position of a cursor displayed on an image via an electric wave emitted from the signal transmitter, operating the signal receiver connected with the CPU to control movement of the cursor displayed on the image; and
(e) controlling the cursor displayed at the relative position of the image to command the image for selection, execution, print, scrolling the window, and hot key.
thereby, the signal receiver getting the relative position of the cursor displayed on image via the electric wave emitted from the signal transmitter, the signal receiver being operated to control the cursor displayed on the image.

9. The cursor control method as claimed in claim 8, wherein the signal transmitter and the signal receiver are connected to the display control machine, the projector and the monitor with USB signal transmission lines for constituting a signal transmission mode.

10. The cursor control method as claimed in claim 8, wherein the signal transmitter and the signal receiver are connected to the display control machine with a Bluetooth wireless transmission device or a radio transmission device for constituting a signal transmission mode.

11. The cursor control method as claimed in claim 8, wherein the signal transmitter and the signal receiver are constituted with Complementary Metal-Oxide-Semiconductor (CMOS).

12. The cursor control method as claimed in claim 8, wherein the signal receiver comprises a left key, a right key, a roller, and a quick key, having mouse functions.

13. The cursor control method as claimed in claim 8, wherein the signal receiver comprises a power switch for a user to operate at an appropriate location.

14. The cursor control method as claimed in claim 8, wherein, a mouse connected with the display control machine is moved for interchanging operation when the signal transmitter and the signal receiver are in use.
